(19) United States
(12) Patent Application Publication
(10) Pub. No.: US 2007/0120942 A1
(43) Pub. Date: May 31, 2007

(54) Dual-sided two color thermal printing

(75) Inventors: Michael J. Van Demark, Springboro, OH (US); Dale R. Lyons, Suwanee, GA (US); Justin L. Collins, Woodstock, GA (US)

Correspondence Address: Douglas S. Foote;Intellectual Property Section, Law Department, NCR Corporation, 1700 South Patterson Blvd., Dayton, OH, 45479-0001, US

(73) Assignee: NCR Corporation

(21) Appl. No.: 11/290,710

(22) Filed: Nov. 30, 2005

(51) Int. Cl. B41J 2/315

(52) U.S. Cl. 347/221

(57) ABSTRACT

A dual-sided imaging direct thermal recording material comprises an opaque substrate, and temperature sensitive coatings for direct thermal printing in different colors on opposite sides of the substrate. Recording material such as a paper transaction receipt on which direct thermal printing on the front side is in one color and direct thermal printing on the reverse side is in a different color is disclosed.

### BACKGROUND

Duplex or dual-sided direct thermal printing of transaction documents or receipts is described in U.S. Pat. Nos. 6,784,906 and 6,759,366. The printers are configured to allow printing on both sides of thermal media moving along a feed path through the printer. In such printers a direct thermal print head is disposed on each side of the media feed path. A thermal print head faces an opposing platen across the feed path from the print head.

In direct thermal printing, a print head selectively applies heat to paper or other sheet media comprising a substrate with a thermally sensitive coating. The coating changes color when heat is applied, by which “printing” is provided on the coated substrate. For dual-sided direct thermal printing, the sheet media substrate may be coated on both sides.

Duplex or dual-sided direct thermal printing has been described for providing variable information on both sides of a paper receipt, to save materials and to provide flexibility in providing information to customers. The printing can be driven electronically or by computer using a computer application program which directs dual-sided printing. A dual-sided direct thermal printer can also be configured for use in conjunction with simplex mode programs for printing of receipts or other documents.

It is known to provide temperature sensitive coatings using two or more dyes for direct thermal printing to be carried out in different colors on one side of the printing media. However direct thermal printing in different colors on opposite sides of the media may be useful in order to call attention to a particular side of the media being printed.

### SUMMARY

A temperature sensitive recording material for two-sided direct thermal printing thereon is described. The material comprises an opaque substrate such as paper having temperature sensitive coatings on opposite sides of the substrate. The coatings change to colors different from one another when heated, so that direct thermal printing on opposite sides of the substrate is in different colors. The material may be in the form of a paper document such as a transaction receipt on which direct thermal printing on the front side is all in one color and direct thermal printing on the reverse side is all in a different color. The color of direct printing on one side of the document may designate the side that is printed.

### BRIEF DESCRIPTION OF DRAWINGS

FIG. 1 shows a schematic of a dual-sided imaging direct thermal printer useable for dual-sided, single pass printing of thermal media such as transaction receipts or tickets.

FIG. 2A shows a receipt with transaction detail printed on the front side.

FIG. 2B shows a receipt with supplemental information printed on the reverse side, such as variable stored information determined at the time of the transaction.

FIG. 3A shows a two-sided receipt with a portion of the associated transaction detail printed on the front side of the receipt.

FIG. 3B shows the reverse side of the receipt shown in FIG. 3A on which the remaining portion of the associated transaction data is printed.

### DETAILED DESCRIPTION

By way of example, various embodiments of the invention are described in the material to follow with reference to the included drawings. Variations may be adopted.

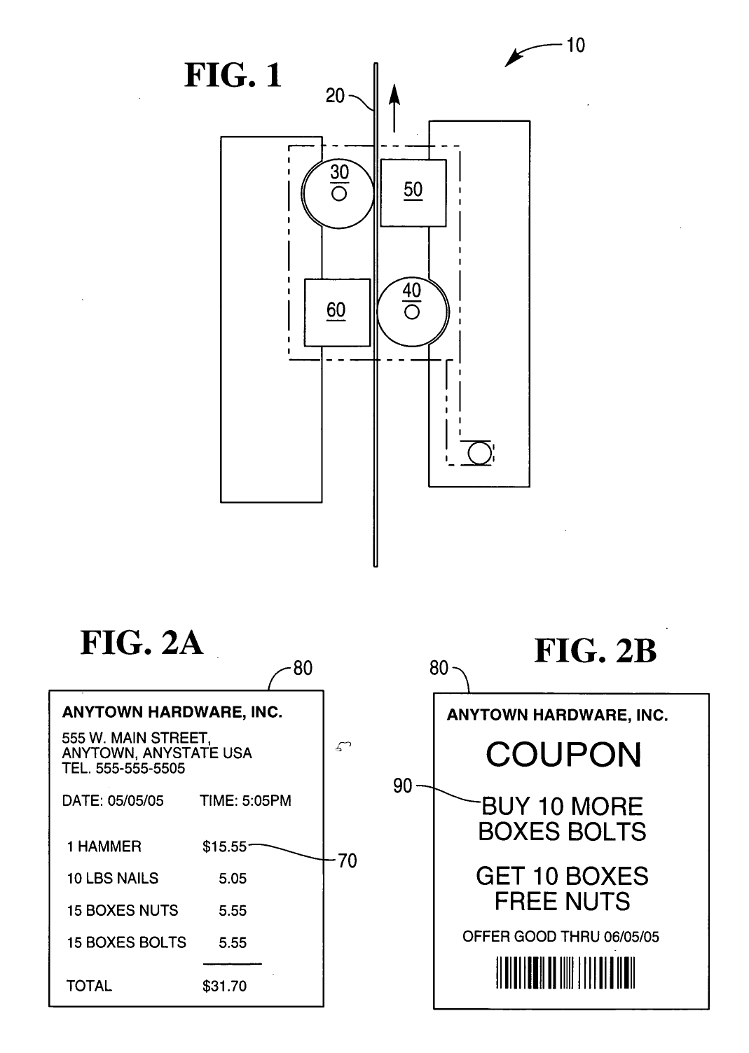

FIG. 1 shows a schematic of a dual-sided imaging direct thermal printer 10 useable for dual-sided, single pass printing of transaction receipts or tickets at time of issue. The printer 10 operates on print media 20 which is double-sided thermal paper comprising an opaque substrate, preferably a cellulosic or polymer substrate sheet coated on each side with heat sensitive dyes as described in U.S. Pat. Nos. 6,784,906 and 6,759,366. Two-color printing capability is provided for two-sided direct thermal printing on opposite sides of the receipt by using a different colored dye on each side. Substrates and heat sensitive color changing coatings for direct thermal printing media are generally well known in the art. Dual-sided direct thermal printing can be facilitated by a media 20 which includes differently colored dyes on opposite sides of the media 20, and a sufficiently thermally resistant substrate that inhibits direct thermal printing on one side of the media 20 from affecting coloration on the opposite side of the media 20.

The thermal print media 20 may be supplied in the form of a paper roll or sheet, e.g., to provide a voucher, coupon, receipt, ticket or other article or document, upon which printing such as graphics or text, or both, may be printed on both sides of the media 20.

As shown in FIG. 1, the printer 10 has rotating platens 30 and 40 and opposing thermal print heads 50 and 60 on opposite sides of the printed thermal media 20. Dual-sided direct thermal printing of the media 20 occurs in a single pass at the time of the transaction or when a receipt or ticket is issued. The media 20 can be cut or severed to provide an individual receipt or ticket document, typically once printing is completed.

FIG. 2A shows transaction detail 70 such as issuer identification, time, date, line item entries and a transaction total printed on the front side of a receipt 80. FIG. 2B shows custom information 90, e.g., based on recipient identity or transaction detail ascertained at transaction time, printed on the reverse side of the receipt 80. For example, custom information 90 could include further or duplicate transaction information, a coupon as shown, rebate or contest information, serialized cartoons, conditions of sale, document images, advertisements, security features, ticket information, or other information, e.g., custom information based on recipient identity or transaction data or detail.

Dual-sided imaging direct thermal printer 10 is configured to allow printing on both sides of a receipt or other sheet media 20 moving along a feed path 25 through the printer 10 with print heads 50 and 60 on opposite sides of the media feed path 25. Print heads 50 and 60 preferably have associated opposing platens 30 and 40 as shown.

A portion, e.g., half, of a block of data to be printed may be printed by direct thermal printing on one side of the media 20, and another portion of the data, e.g., half, may be printed by direct thermal printing on the reverse side of the media 20, or the media sides on which the respective portions of data are printed may be reversed. In this manner a transaction receipt may be generated in which a portion of the associated transaction data is printed on one side of the receipt and the remaining portion of the transaction data is printed on the other side of the receipt, conserving upon the amount of media 20 required for printing of the receipt. A dual-sided direct thermal printing function may be further be used to determine the portion or quantity of data, or a block of data, to be printed on a side of the media 20. Different blocks of data may be alternatively selected for printing.

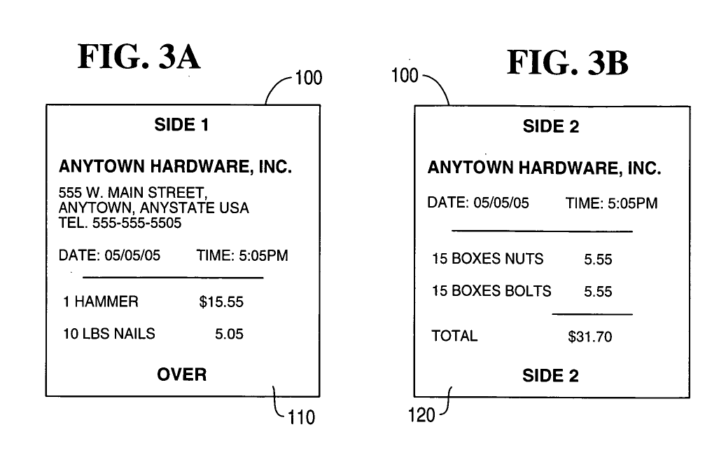

FIG. 3A shows a two-sided receipt 100 with a portion of the associated transaction detail printed on the front side 110 of the receipt 100. FIG. 3B shows the reverse side 120 of the receipt 100 shown in FIG. 3A, where the remaining portion of the associated transaction data is shown printed on the reverse side 120 of the receipt 100. Indicia such as “Front Side,” Reverse Side, “Side 1,” “Side 2,” or the like may be included on the two sides of the receipt 100 as shown to denote the two-sided nature of the receipt 100 or the respective side of the receipt 100 being viewed. Identifying indicia such as a receipt or transaction number, terminal number, store identifier, date, time or the like may be printed on both sides of the receipt to enable association of copied images of the two sides.

A dual-sided imaging direct thermal printer 10 having pre-print data storage facilities may store one or more blocks of data to be repetitively printed on a side of the media 20, e.g., with data submitted by application software to be printed on the other media side. Where multiple data blocks are stored in the printer storage, the blocks may be alternatively selected for printing, as may be the media printing side selection.

The media 20 is a temperature sensitive recording material for two-sided, two-color direct thermal printing in a different color on opposite sides of the material. The media 30 comprises an opaque substrate having temperature sensitive coatings on opposite sides of the substrate. The coatings change to colors different from one another when heated, so that direct thermal printing on one side of the substrate is in a color different than the color of direct thermal printing on the other side of the substrate. The substrate preferably has a sufficient thermal resistance to prevent heat applied to one side of the media 20 from activating a color change on the opposite side of the media 20.

The media 20 may use a primer material disposed beneath the temperature sensitive coatings on the opposite sides of the opaque substrate to adhere the coatings. The primer material may render the substrate opaque if not already opaque. The coatings may be disposed between the primer material and a protective top coat material.

By using a dual-sided, two-color direct thermal imaging material for the media 20 with a first temperature sensitive coating on the front side of the substrate, and a second temperature sensitive coating on the reverse side of the substrate, the first coating changes to a first color when heated and the second coating changes to a second color different from the first color when heated, so that direct thermal printing on the front side of the substrate is in a color different than the color of direct thermal printing on the reverse side of the substrate. The media 20 may thus be deployed to create a document printed by two-sided direct thermal printing on which direct thermal printing on the front side of the document is in one color and direct thermal printing on the reverse side of the document is in a different color, whereby the color of direct thermal printing designates the side of the document that is printed. For example, direct thermal printing on the front side of a receipt may be in black, to designate the front side of the receipt, and direct thermal printing on the reverse side of the receipt may be in red to designate the reverse side. The dual-sided, two-color direct thermal printing may also be used to call particular attention to the printing on one side of the media 20, such as terms of sale or promotional material thermally printed in red on the reverse side of a receipt or other transaction document.

The description above presents a number of specific embodiments or examples of a broader invention. The invention is also carried out in a wide variety of other alternative ways which have not been described here. Many other embodiments or variations of the invention may also be carried out within the scope of the following claims.

What is claimed is:

1. A temperature sensitive recording material for two-sided direct thermal printing thereon, comprising an opaque substrate having temperature sensitive coatings on opposite sides said substrate, which coatings change to colors different from one another when heated, whereby direct thermal printing on one side of said substrate is in a color different than the color of direct thermal printing on the other side of said substrate.

2. The temperature sensitive material of claim 1 in which said substrate has a sufficient thermal resistance to prevent heat applied to one of said coatings from activating a color change in the other of said coatings.

3. The temperature sensitive recording material of claim 1 in which said substrate has primer material disposed beneath said coatings on said opposite sides of said substrate.

4. The temperature sensitive recording material of claim 1 in which each of said coatings is disposed between said primer material and a protective top coat material.

5. A temperature sensitive recording material for two-sided direct thermal printing thereon, comprising an opaque substrate having a first temperature sensitive layer on one side of said substrate, and a second temperature sensitive layer on a side of said substrate opposite said one side of said substrate, where said first and second temperature sensitive layers change to colors different from one another when heated, enabling one of said colors to represent thermal printing on said one of said sides, and enabling the other of said colors to represent thermal printing on the other of said sides of said substrate.

6. A recording material for two-sided direct thermal printing thereon, comprising an opaque substrate having a first temperature sensitive coating on first side of said substrate, and having a second temperature sensitive coating on a second side of said substrate opposite said first side, said first coating changing to a first color when heated and said second coating changing to a second color different from said first color when heated, whereby direct thermal printing on said first side of said substrate is in a color different than the color of direct thermal printing on said second side of said substrate.

7. A document comprising an opaque substrate printed by two-sided direct thermal printing on which direct thermal printing on the front side of the document is in one color and direct thermal printing on the reverse side of the document is in a second color different from said one color, whereby the color of direct thermal printing designates the side of the document that is printed.

8. The document of claim 7 in the form of a paper transaction receipt.

9. A recording material for two-sided two-color direct thermal printing thereon, comprising an opaque substrate, a temperature sensitive coating for direct thermal printing in only one color on one side of said substrate, and a temperature sensitive coating for direct thermal printing only in a different color on the opposite side of said substrate.
